(19) United States
(12) Patent Application Publication
(10) Pub. No.: US 2009/0078798 A1
(43) Pub. Date: Mar. 26, 2009

(54) Fluid Injection Valve

(76) Inventors: Andreas Gruendl, Starnberg (DE); Bernhard Hoffmann, Starnberg (DE); Friedrich Mortl, Starnberg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/212,224

(22) Filed: Sep. 17, 2008

(30) Foreign Application Priority Data
Sep. 20, 2007 (DE) 10 2007 044 877.7

(51) Int. Cl. B05B 1/30

(52) U.S. Cl. 239/584

(57) ABSTRACT

A fluid injection valve has an inlet, which is set up to receive fluid from a supply line, and which is connected to a chamber, a fluid outlet, which is connected to the chamber, and which is set up to allow fluid to flow out of the fluid injection valve, and a valve arrangement, having a valve seat and a valve member, the valve member being set up to execute opening and closing movements relative to the valve seat. A linear actuator is set up to move the valve member relative to the valve seat, and a spring arrangement exerts on the valve member a spring force which is dependent on the fluid pressure prevailing in the chamber.

### BACKGROUND

In the following, a description is given in general of a fluid injection valve, for example for injecting fuel directly into a combustion chamber of an internal combustion engine. The fluid injection valve disclosed here is to be used both in the case of directly injecting engines and in the case of conventional engines that inject into the induction pipe. It is, however, not limited to fuel injection systems, where fuel is to be understood in this context both as hydrocarbons and hydrogen. It may also be employed in other applications where the precisely controlled and/or metered introduction of fluid into a space, an operating region or a working chamber is required or desirable.

The structure and mode of operation will now be explained using a fluid injection valve for injecting fuel into a combustion chamber of an internal combustion engine.

Owing to the continually growing requirements of the legislation on exhaust emissions, with limit values being reduced further, the challenge faced is that of optimising the formation of pollutants at their place of origin by optimising the process of injecting fuel into the combustion chamber. Particularly critical are emissions of CO₂, NO, and fine dust. Although it is possible to keep to current limit values through the development of injection systems with ever-higher injection pressures and highly dynamic injectors, and by means of cooled exhaust-gas recirculation and oxidising converters, it nevertheless appears that the existing measures for reducing emissions have reached their potential.

However, for a cleaner combustion of fuel in internal combustion engines, but also in other applications, it is important for the fluid, i.e. for example the fuel, to be metered particularly precisely and also for variable quantities to be delivered at a high repetition rate. With known injection systems, however, it is possible only with difficulty to control the accuracy of the metering with the dynamics required, for example, for a fast-running internal combustion engine.

### PRIOR ART

Storage injection systems (so-called common rail systems) have a pressure generation and the fuel injection completely uncoupled from one another. A separate high-pressure pump generates pressure in the fuel supply line continuously for all the injection valves of an internal combustion engine. Thus, the fuel pressure is built up independently of the injection sequence and is permanently available in the fuel line. Nevertheless, pressure fluctuations occur, which affect the quantity of fuel injected into the combustion chamber. The continuously present high pressure of more than 1350 bar is stored in the so-called rail and made available via short injection lines to the fast-switching piezoelectric or solenoid valves (injectors) of a cylinder bank of the internal combustion engine.

Particularly with inward-opening valves, there is the following problem: When the valve is closed, owing to the high pressure in the valve housing (2000 to 2500 bar and above), very high closing or retention forces act on the valve member seated on the valve seat. These forces have to be overcome by a controlled actuator on opening of the valve. Therefore, the (for example electromagnetically or piezoelectrically operating) actuator must be designed with appropriate power data. Conventional electromagnetic or piezoelectric actuators are thus of relatively large size and require high electric power. Moreover, the electronic control driving them, and the control lines, also have to be appropriately dimensioned (electrically and mechanically).

There are studies (by FIAT) for a fluid injection valve for fuel injection having a piston which is coupled to the valve member and generates a force opposite to the closing force. The piston is in this case dimensioned in such a way that it relieves the valve member in dependence on the pressure in the interior of the valve housing such that the valve member is loaded with approximately the same low closing force at any time. On opening of the valve, the piston enables an unpressurised fuel recirculation to the fuel tank. This piston and a bush surrounding it have to be very precisely manufactured in this case; in addition, they are subjected to appreciable wear over the service life of the fluid injection valve. The unpressurised fuel recirculation required here represents a considerable outlay with regard to space requirement and manufacture.

A fuel injection valve for an internal combustion engine, having a metering opening which is connected to a supply line for pressurised medium to be metered, is known from DE 40 05 455 A1 (Volkswagen AG). A valve needle, which closes and opens a valve and is displaceably mounted in a valve housing, is opened by an actuating member, while the closing movement of the valve needle is effected by spring force. The spring force is generated by a spring diaphragm arranged in the valve housing. This spring diaphragm seals a first space, free of the medium and containing the actuating member, from a second space containing the medium. Since the actuating member is a temperature- and humidity-sensitive piezoelectric actuator, the separation by the spring diaphragm achieves a sealing of the actuating member from the medium to be metered, virtually without any additional outlay.

A fluid metering device for pressurised fuels having a pressure up to 500 bar, for example, is known from EP 1 046 809 A2 (Siemens AG). For this fluid metering device having a piezoelectric actuator as the drive, the leadthrough of the valve needle from the pressurised fuel chamber into the drive part of the injector has to be designed in a hermetically sealed manner. The leadthrough element is a metal bellows and has a high mechanical flexibility in the movement direction of the valve needle, in order not to impair the deflection of the latter and in order to keep low the forces introduced into the valve needle by temperature-induced length changes of the leadthrough element. Pressure-induced forces which act directly on the valve needle or which are introduced into the valve needle by elements mechanically connected to the valve needle, such as the leadthrough element, are compensated for. This fluid metering device ensures a hermetically sealed leadthrough of a valve needle through a chamber filled with a pressurised fluid, the leadthrough element not exerting any substantial pressure-dependent forces on the valve needle. The leadthrough element compensates for the pressure-induced forces acting on the valve needle, in order to make the valve needle as a whole free from pressure forces.

A piezoelectric actuator module for an injector in the high-pressure part of a common rail injection system of a motor vehicle is known from DE 102 33 100 A1 (ROBERT BOSCH GMBH). This piezoelectric actuator module has a piezoelectric element, an actuator foot and an actuator head, which cooperates with a component to be actuated by the piezoelectric element. The actuator module is surrounded by a sleeve extending in the axial direction. Adjoining the actuator foot is a radially extending diaphragm which is connected to the sleeve and has a cross-section with different radii of curvature.

The diaphragm seals the actuator module in the axial direction. It forms, together with the sleeve radially bounding the actuator module, a protective casing of the actuator module. The components comprising the actuator foot, the piezoelectric element, the actuator head, the sleeve and the diaphragm taken as a whole thus form a kind of piezoelectric actuator cartridge.

DE 37 04 541 A1 (VDO) relates to a fuel injection valve for an internal combustion engine, which has a sealing element connected to a spring element and to a centring element. In this case, the spring element in the form of a diaphragm spring serves to press the sealing element connected to the armature of an electromagnet onto a valve seat body. The sealing element is lifted off from the valve seat body by the electromagnet during the actuating process.

### Underlying Problem

In view of these known arrangements, a fluid injection valve which at least partly overcomes the disadvantages of the prior art is to be proposed.

### Solution According to the Invention

To this end, a fluid injection valve having the features of claim 1 is proposed. This valve has a housing and an inlet, which is set up to receive fluid from a supply line, and which is connected to a chamber. The fluid injection valve furthermore has a fluid outlet, which is likewise connected to the chamber. The fluid outlet is set up to allow fluid to flow out of the valve. The fluid injection valve has a valve arrangement, having a valve seat and a valve member. The valve member is set up to execute opening and closing movements relative to the valve seat. The fluid injection valve may have a linear actuator, which is set up to move the valve member relative to the valve seat. Furthermore, the housing has a substantially cylindrical shape, its wall thickness and material being determined in such a way that fluid pressures occurring in the chamber cause a lengthening and/or widening of the housing. A first spring arrangement exerts on the valve member a spring force which is dependent on the fluid pressure prevailing in the chamber. The first spring arrangement is fixedly connected to the housing and assists the linear actuator in lifting off the valve member from its valve seat when the fluid pressure in the chamber increases.

This arrangement has the effect that a fluid pressure (provided by the rail for example) prevailing in the chamber contributes to the force effecting the process of lifting off the valve member from its valve seat. Thus, with this arrangement, the actuator (and also the electronics controlling it) applying this force by itself in otherwise comparable conventional valves can be dimensioned smaller. As an alternative to this, the valve member can lift off from its valve seat with greater dynamics than with conventional valves. With this fluid injection valve, use is in this case made of the fact that, at least when the valve member opens inwards (in the direction of the valve chamber), the force required for lifting off the valve member from the valve seat decreases rapidly and when the valve is open amounts to only approximately one third to approximately one seventh of the original force.

Pressure fluctuations arise, on the one hand, owing to the operating pressure of the feed pump varying, for example, between approximately 5% and approximately 110% of the nominal pressure. On the other hand, there arise pulsations of a feed pump supplying the fluid injection valve or pulsations on account of valve opening processes in adjacent fluid injection valves supplied by the same feed pump.

The fluid injection valve presented is capable of at least partly compensating for such pressure fluctuations. It is thus possible to markedly improve the metering behaviour of the fluid injection valve. In the case of fuel injection systems in internal combustion engines, this helps to reduce the fuel consumption and consequently the emissions. With the fluid injection valve in which the first spring arrangement exerts on the valve member a spring force which is dependent on the fluid pressure prevailing in the chamber, not only can the opening time and the opening stroke of the valve member relative to the valve seat be better controlled; the speed profile of the opening stroke can also be more precisely defined. This is due to the fact that the pressure fluctuations of the supplied fluid are at least partly eliminated, so that they no longer influence the valve member. It is thus possible to control the valve actuation even more precisely than is the case with known arrangements. The resulting fuel saving—and consequently also the reduction of exhaust gases—can amount to several percent.

This appreciable saving also results from the fact that the actuators of known injectors have to be designed to compensate for the possible pressure fluctuations; that is to say they have to apply the necessary closing and actuating forces also in unfavourable fluid pressure conditions in the chamber of the fluid injection valve. If, now, these pressure fluctuations are at least partly compensated for, a more dynamic actuation of the fluid injection valve can take place—for the same constructional size and the same power data. As an alternative to this, injection valves of smaller size and with comparable power data may also be provided. Moreover, the movement of the valve member relative to the valve seat can be better controlled, so that, for example, a considerably “smoother lengthening” of the valve member in the valve seat than with previous arrangements is made possible. This increases the service life and reduces the noise generation in the fluid injection valve.

With this configuration of the fluid injection valve, the first spring arrangement can integrally combine two functions which can, however, also be realised in spring arrangements physically separate from one another: on the one hand, the presetting of the travel over which the linear actuator is to be assisted during the lifting/lowering of the valve needle, and on the other hand, the shaping of the force/travel characteristic in the desired manner, which is to be superimposed on the travel presetting.

### Developments and Configurations

In the fluid injection valve, the spring arrangement can be designed and dimensioned in such a way that it exerts on the valve member a spring force proportional to the fluid pressure prevailing in the chamber. Thus—in a tension spring configuration—with a high fluid pressure prevailing in the chamber a high spring force pulls on the valve member, and with a low fluid pressure prevailing in the chamber a low spring force pulls on the valve member.

In this case, the spring arrangement of the fluid injection valve can be arranged and configured in such a way that it exerts a force which acts on the valve member in the direction of an opening of the valve. Thus, the force to be applied by the linear actuator in order to open the fluid injection valve is reduced.

In one embodiment, the first spring arrangement has a rest state with a prestress, the prestress exerting on the valve member approximately one quarter to three quarters (for example approximately half) of the force exerted by the fluid pumped into the chamber. It is also possible, instead of using the first spring arrangement with a prestress, to provide a second spring arrangement which applies the prestress to the valve member, and to use the first spring arrangement without prestress.

This second spring arrangement may be a helical spring which acts—directly or indirectly—on the valve member and is configured either as a tension or push spring.

The first spring arrangement can be formed by at least one arrangement similar to a cup spring, of which the spring force exerted on the valve member varies in the same sense as the fluid pressure prevailing in the chamber. The shape of the cup-spring arrangement, which can be produced, for example, from heat-resistant and/or rustproof and/or corrosion-resistant spring steel or special steel, is chosen in this case in such a way that it acts as a (prestressed) tension or compression spring between the stationary housing of the fluid injection valve and the valve member movable relative thereto.

In this case, the first spring arrangement can have a substantially frustoconical shape, the spring arrangement being designed and dimensioned in such a way that it shortens in the direction of the opening movement of the valve member with rising fluid pressure.

This can be achieved in that the outer edge of the substantially frustoconical spring arrangement is fixedly connected (for example (laser-)welded) to the housing of the fluid injection valve, while the inner edge is set up to pull the valve member from its valve seat when the fluid pressure in the housing of the fluid injection valve increases. Instead of welding the frustoconical spring arrangement to the housing, the spring arrangement can also be realised as a stamped-pressed part which has on its outer circumference, for example, a bead or an annular collar. This bead can then engage in an annular groove in the inner wall of the housing when the spring arrangement is pressed under prestress into the housing. It is understood that the bead can also be formed on the inner wall of the housing and the annular groove on the outer circumference of the frustoconical spring arrangement.

In this case, the cup-spring arrangement can be connected to the housing with such prestress that, even at maximum extension of the housing (extension caused by fluid pressure and/or temperature), a residual prestress still remains. It can thus be achieved that in this state the cup-spring arrangement does not act as a spring arrangement, but as a transforming lever which transforms the change in diameter of the housing into a change in length. This change in length can then act on a separate cup-spring arrangement in which a falling force/travel characteristic is implemented. The hydraulic force/travel characteristic can thus simulate an inward-opening valve arrangement.

In this case, the cup-spring-like shape is ultimately used oppositely to a conventional cup spring: In a conventional cup spring, the (pushing) force is introduced substantially along its central longitudinal axis. In contrast to this, in the arrangement, a pressure increase in the housing of the fluid injection valve results on the one hand in the widening of the latter in the diameter direction. The frustoconical spring arrangement can be fixedly connected at its outer edge to the housing of the fluid injection valve. Thus, the (pulling) force is initiated substantially radially along the circumference of the frustoconical spring arrangement. This pulling force at the outer edge resulting from the widening of the housing in the diameter direction causes a shortening of the frustoconical spring arrangement along its central longitudinal axis. At the inner edge of the frustoconical spring arrangement, the latter can act—directly or indirectly—on an annular collar formed on a rod coupled to the valve member. If the cone of the frustoconical spring arrangement is arranged in a manner tapering in the direction towards the valve seat, a widening of the diameter results in a pulling force on the valve member away from the valve seat.

On the other hand, in the present arrangement, a widening resulting from a pressure increase in the housing of the fluid injection valve also acts in the longitudinal direction of the latter. The frustoconical spring arrangement is fixedly connected at its outer edge to the housing of the fluid injection valve. Since the cone of the frustoconical spring arrangement is arranged in a manner tapering in the direction towards the valve seat, the inner edge of the frustoconical spring arrangement is moved away from the valve seat on a lengthening of the housing along its central longitudinal axis. The inner edge of the frustoconical spring arrangement engages—directly or indirectly—on the annular collar and in the process takes along with the latter the rod coupled to the valve member. Thus, there acts on the valve member a force which acts away from the valve seat and assists the lifting-off of the valve member from the valve seat.

The housing can in this case have a substantially (circular-)cylindrical shape. Its wall thickness and material are determined in such a way that, at the fluid pressures occurring in the fluid injection valve, the above-described lengthening and widening of the housing takes place as elastic deformation of the housing material.

A substantially plane annular collar adjoins the inner edge of the frustoconical spring arrangement, a second frustum of a cone directed towards the centre being formed on the plane annular collar. The second frustum of a cone can be smaller than the first frustoconical spring arrangement and be oriented oppositely to the latter, that is to say taper in a manner directed away from the valve seat.

The first frustoconical spring arrangement can have a cone angle of approximately 0.5°-30° in the rest position; with maximum widening of the housing in the diameter direction (that is to say on application of the maximum operating pressure of the fluid at the inlet), this cone angle can be reduced to approximately three quarters to one quarter of the rest position value. The second frustum of a cone can have a cone angle of approximately 15°-56° in the rest position. The flatter the cone angle of the second frustum of a cone, the less the latter is deformed when the valve member is lifted off from the valve seat; the stiffer the arrangement is. It is understood that all intermediate values of the given ranges of the cone angles are also to be regarded as being disclosed.

The second frustum of a cone can have a force-travel spring characteristic by which an opening force inversely proportional to the opening stroke travel of the valve member is exerted on the valve member.

The linear actuator can have a plurality of configurations, for example that of a piezoelectric actuator; however, the linear actuator is preferably an electromagnet arrangement having a stator and a rotor. The rotor can be kinematically coupled to the valve member or be a part of the valve member. As an alternative to this, the valve member can also be an integral part of the rotor.

In this case, the stator can be designed as a multipole stator which has a plurality of stator poles arranged spaced apart side by side and a plurality of excitation coils associated with the respective stator poles and arranged between in each case two stator poles. Multipole stator in the context of the present invention is understood to mean an arrangement of two or more pole webs of cylindrical (e.g. round or oval) or polygonal (e.g. triangular, quadrangular or hexagonal) cross-section, which are arranged on a surface, e.g. a plane, and are surrounded by one or more coil arrangements. Each pole web can in this case have its own coil arrangement associated with it, or one coil arrangement is wound around a plurality of pole webs. This allows the generation of a high magnetic force density, which is manifested in a magnetic field building up and weakening very rapidly and in a highly dynamic valve switching behaviour.

Analogously to this, the armature can be designed as a multipole armature, the armature poles of which are aligned with the respective stator poles. In this case, the armature poles can be formed by diminutions and thickenings of the armature plate, which otherwise substantially follows the contour of the end face of all the pole webs taken as a whole.

The electromagnet arrangement can have between the stator and the armature a working air gap preferably oriented transversely with respect to the movement direction of the armature. Depending on the spatial conditions, it is also possible to orient the working air gap differently.

The second spring arrangement can be dimensioned and designed according to a spring characteristic in such a way that the falling closing-force spring characteristic of the (inward-opening) valve arrangement is compensated for. In the case of an outward-opening valve arrangement, the closing-force spring characteristic can be set to a constant force. The setting of the respective spring characteristic can be achieved by the geometry of the (cup-)spring arrangement.

In one embodiment, the stator and/or the armature of the linear actuator are arranged in the interior of the chamber.

In order to enable an as far as possible unimpeded flow of the fuel, the stator and/or the armature have at least one fluid passage for fluid in the direction towards the valve arrangement.

In order to be able to realise particularly slender and elongated structural forms with large retention or closing forces, a cascading of a plurality of electromagnet arrangements acting on the valve arrangement can be carried out. In this case, the electromagnet arrangements acting on the valve arrangements can be oriented either in the same direction or in opposite directions.

The linear actuator for the valve device can be provided to act on a movable valve member in order to move said valve member, relative to a stationary valve seat cooperating with the valve member and arranged downstream of the fluid inlet, between an open position and a closed position. A directly switching valve arrangement can thus be realised.

The fluid injection valve can be configured, set up and dimensioned as a fuel injection valve arrangement in order to project into the combustion chamber of a spark-ignition or compression-ignition internal combustion engine.

Further advantages, configurations or possible variations will become apparent from the following description of the figures, in which the invention is explained in detail.

### BRIEF DESCRIPTION OF THE FIGURES

FIG. 1a shows a schematic illustration in longitudinal section through a fluid injection valve in the closed position.

FIG. 1b shows a schematic illustration in longitudinal section through the fluid injection valve according to FIG. 1a in the open position.

FIG. 2 shows a schematic perspective illustration of a spring element.

Proportions and dimensions in the figures are not necessarily to scale in relation to real arrangements of fluid injection valves. Rather, they serve to provide a better representation of the circumstances to be illustrated.

### DETAILED DESCRIPTION OF THE FIGURES

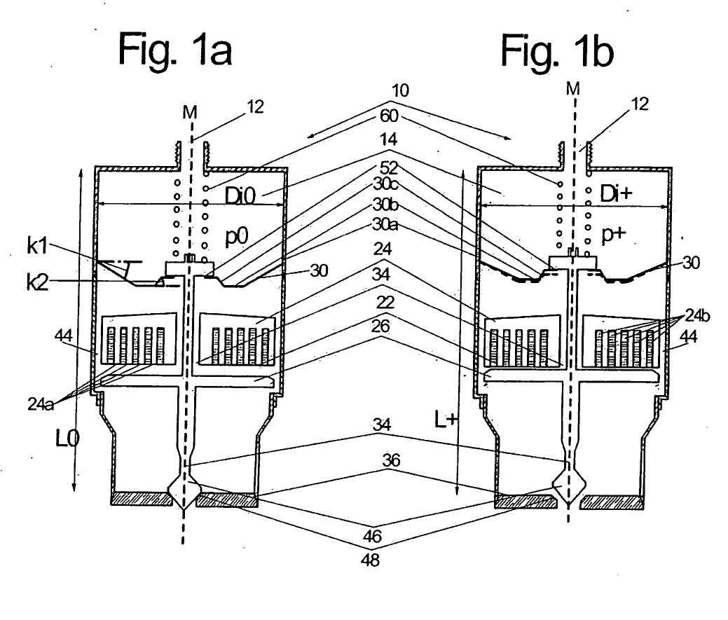

FIG. 1a shows a fluid injection valve 10 having a housing substantially rotationally symmetrical with respect to a central longitudinal axis M in schematic longitudinal section in a closed position, while FIG. 1b shows such a fluid injection valve in an open position. Such a fluid injection valve may serve to directly inject fluid in the form of fuel into the combustion chamber—not illustrated further—of an internal combustion engine. The fluid injection valve 10 has (at the top in FIG. 1) a central fluid inlet 12, through which fluid can flow from a fluid distribution line—not illustrated further—to a chamber 14 of the fluid injection valve 10.

The chamber 14 of the fluid injection valve 10 has a shape substantially circular-cylindrical in cross-section. At a distance from the inlet 12, an electromagnet arrangement 22 is arranged. The electromagnet arrangement 22 has a stator 24, arranged in the interior of the chamber 14 and formed from soft iron (plates) and having a shape substantially circular-cylindrical in cross-section, and a disc-shaped armature as a rotor 26, likewise arranged in the interior of the chamber 14 and substantially circular-cylindrical. In this case, the stator 24 is designed as a multipole stator having elongate stator poles 24a which are spaced apart side by side or concentric. In the stator 24, a plurality of excitation coils 24b are associated with the respective stator poles 24a in a manner surrounding the latter. Likewise, the disc-shaped armature 26 can be designed as a multipole armature, the armature poles of which are aligned with the respective stator poles. The armature 26 can thus move along the central longitudinal axis M. The armature/rotor 26 is rigidly connected at its other end face (at the bottom in FIG. 1) to a valve needle 34. The valve needle 34 passes through a central opening in the stator 24 and carries at its free end (at the bottom in FIG. 1) a valve member 46, which is longitudinally movable along the central axis M. The valve member 46 is part of a valve arrangement 46, 48 having the valve member 46 and a valve seat 48, in order to discharge the fluid in a controlled manner. The valve seat tapers conically in the flow direction; the valve member 46 is correspondingly shaped and cooperates with the valve seat 48. The valve member 46 is moved by the valve needle 34, relative to the stationary valve seat 48 cooperating with the valve member 46 and arranged downstream of the fluid inlet 12, between an open position and a closed position (up and down in FIG. 1). For this purpose, the valve seat is formed in a bush 36 which closes off the chamber 14.

Formed between the stator 24 and the armature 26 is a working air gap which is oriented transversely with respect to the movement direction of the armature 26. In this case, the difference between the minimum and maximum extent of the working air gap in the direction of the central longitudinal axis M constitutes the stroke by which the valve member 46 can lift off from the valve seat 48.

The stator 24 is surrounded by an annular gap 44, through which fluid situated in the chamber 14 can pass to the valve arrangement 46, 48.

The multipole stator 24 has an arrangement of a plurality of, in cross-section or plan view, cylindrical, polygonal pole webs 24a which are arranged in a surface. These pole webs, rectangular in the present example, may also be of substantially square or trapezoidal shape in plan view. They are surrounded by one or more coil arrangements 24b. In the present embodiment, each pole web has its own coil arrangement associated with it and surrounding it. It is, however, also possible for one coil arrangement to be wound around a plurality of pole webs. It is, however, understood that the coil arrangements can share the space between two adjacent pole webs. The multipole stator may be formed from one-piece soft iron, from which the pole webs and the intermediate spaces are shaped. Cutouts in the form of slots, in plan view longitudinally running grooves, or elongated holes may be formed in such a one-piece soft-iron shaped part. It is, however, also possible to produce the magnet yoke arrangement as a shaped part from sintered iron powder or to assemble it from a multiplicity of sheet-metal layers or a plurality of sections and optionally bond them together.

The armature 26 is a circular soft-iron-containing disc with a shape described in detail below. The multipole stator 24 and the armature 26 overlap in the radial direction with respect to the central axis M. The multipole stator 24 has approximately the same outside diameter as the armature 26, so that the magnetic flux originating from the coil arrangements 24b can penetrate into the armature 26 virtually without appreciable leakage losses. There is thus realised a particularly efficient magnetic circuit, which allows very short valve opening/closing times and high retention forces.

Irrespective of the design of the multipole stator 24 and the coil arrangements 24b, the armature 26 may also be a closed circular disc of soft iron, provided that the configuration of the magnet yoke and magnet coil arrangement ensures that the leakage losses or eddy current losses are small enough for the respective application. To reduce the weight while ensuring optimised magnetic flux density, the armature is designed as a multipole armature, the armature poles of which are aligned with the respective stator poles. For this purpose, the armature poles are formed by diminutions and thickenings of the armature plate, which otherwise substantially follows the contour of the end face of all the pole webs taken as a whole.

On energising the excitation coils 24b, a magnetic field low in eddy currents is induced in the stator poles 24a and pulls the armature 26 with the valve needle 34 in the direction of the stator 24. The valve member 46 thus moves away from the valve seat 48 into its open position and fluid coming from the fluid inlet 12 can flow in a controlled manner, for example, into the combustion chamber of a spark-ignition or compression-ignition internal combustion engine.

A spring arrangement 30 is arranged in the fluid injection valve 10 in such a way that it exerts a (pulling) spring force, varying in the same sense as the fluid pressure prevailing in the chamber 14, on the valve member 46. The spring arrangement 30 is in this case arranged and configured in such a way that it assists a lifting-off of the valve member 46 from the valve seat 48 initiated by the linear actuator. This reduces the force to be applied by the linear actuator in order to open the fluid injection valve.

In FIG. 1a the first spring arrangement 30 is in an unstressed rest state. A second spring arrangement 60 serves to apply a prestress to the valve member 46 in a closing direction. This second spring arrangement 60 is a helical spring which acts on the valve member 46 and is configured here as a push spring. In this case, the armature disc 26 with the valve needle 34 is loaded by the spring arrangement 60 arranged coaxially with the central axis M, so that the valve member 46 is seated fluid-tightly in the valve seat 48, that is to say is urged into its closed position.

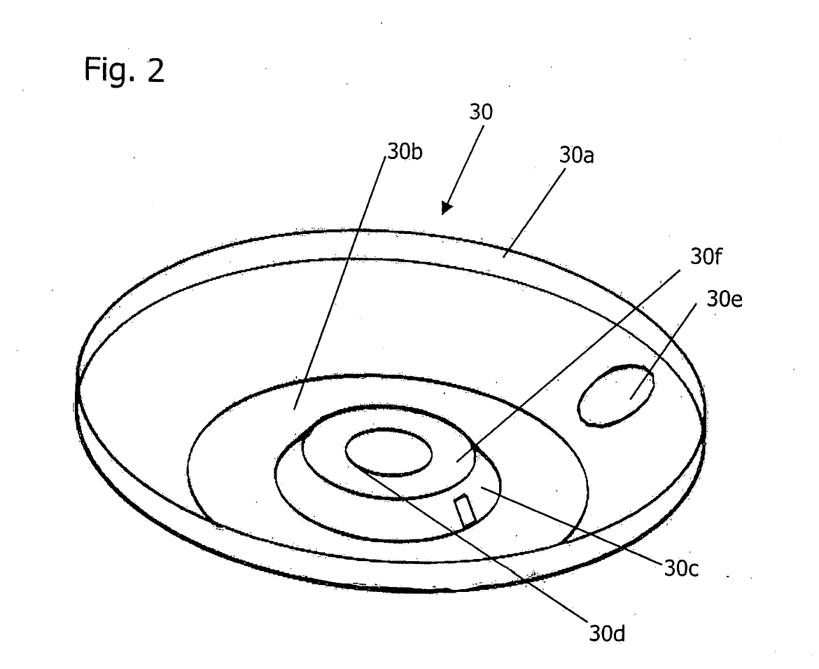

The first spring arrangement 30 is essentially a kind of cup-spring arrangement (see also FIG. 2 in this regard), of which the spring force exerted on the valve member 46 varies with pressure of the fluid prevailing in the chamber 14. The first spring arrangement 30 is produced from corrosion-resistant spring steel. It has a substantially frustoconical shape and, when the fluid pressure rises, shortens along the movement direction of the valve member 46. For this purpose, the cone of the frustoconical spring arrangement 30 is configured in a manner tapering in the direction towards the valve seat 48.

The frustoconical first spring arrangement 30 has an outer collar or edge 30a, here fixedly connected to the housing of the fluid injection valve. On the inner edge of the frustoconical spring arrangement 30 is formed a substantially plane annular collar 30b. From the latter a second frustum of a cone 30c with a supporting collar 30d extends towards the centre (central longitudinal axis M). The supporting collar 30d encompasses the valve needle 34, which has an annular collar 52 on which the supporting collar 30d rests loosely, and pulls the valve needle 34 into its open position when the pressure in the chamber 14 increases.

The second frustum of a cone 30c is shorter along the direction of the central longitudinal axis than the first frustoconical spring arrangement 30 and is oriented oppositely to it. This whole arrangement assists the linear actuator in pulling the valve member 46 from its valve seat 48 when the fluid pressure in the chamber 14 of the fluid injection valve 10 has increased (from p0 in FIG. 1a to p+ in FIG. 1b).

After the lifting-off of the valve member 46 from the valve seat 48, the hydraulic closing force acting on the valve member 46 decreases very sharply, approximately linearly with the stroke of the valve member 46. The prestressing force of the second frustum of a cone 30c must drop to approximately the same degree on opening of the valve, in order to achieve a rapid closure of the valve via the hydraulic closing force still remaining and the force from the spring arrangement 60, with the linear actuator de-energised. The force/travel spring characteristic of the second frustum of a cone 30c can be appropriately designed for this.

The first frustoconical spring arrangement has a cone angle k1 of approximately 25° in the rest position (FIG. 1a). On application of the operating pressure p+ of the fluid at the inlet 12, the housing/chamber 14 is widened in the diameter direction to the diameter Di+ (see FIG. 1b). To illustrate this, the rest position of the spring arrangement is shown dashed in FIG. 1b. The second frustum of a cone 30c has a cone angle k2 of approximately 45° in the rest position.

Lengthening of the chamber 14 (from L0 in FIG. 1a to L+ in FIG. 1b) also results from a pressure increase from the rest state to the operating state in the chamber 14. Since the spring arrangement 30-30d is fixedly connected at its outer edge 30a to the housing/inner wall of the chamber 14 of the fluid injection valve 10, the inner edge 30d of the spring arrangement is moved away along its central longitudinal axis from the valve seat on a lengthening of the housing. The valve needle 34 is taken along in the process, so that, owing to this lengthening effect too, a force directed away from the valve seat acts on the valve member and assists the lifting-off of the valve member from the valve seat.

One or more round (circular), oval, or elongated or polygonal cutouts 30e, 30f (of which only one each is illustrated in FIG. 2) are formed in the conical surfaces 30 and 30c in order to shape the spring behaviour along the circumference.

The variants and their individual aspects explained in the above description of the invention may, of course, be combined with one another, even if such combinations have not been explicitly explained in detail above.

1. A fluid injection valve having a housing,
an inlet, which
is set up to receive fluid from a supply line, and
is connected to a chamber,
a fluid outlet, which
is connected to the chamber, and
which is set up to allow fluid to flow out of the fluid injection valve, and
has a valve arrangement, having
a valve seat and
a valve member,
the valve member being set up to execute opening and closing movements relative to the valve seat,
a linear actuator, which is set up to move the valve member relative to the valve seat, characterised in that
wall thickness and material of the housing are determined in such a way that fluid pressures occurring in the chamber cause a lengthening and/or widening of the housing
a first spring arrangement is fixedly connected to the housing and exerts on the valve member a spring force which is dependent on the fluid pressure prevailing in the chamber in order to assist the linear actuator in lifting off the valve member from its valve seat when the fluid pressure in the chamber increases.

2. The fluid injection valve according to claim 1, wherein the first spring arrangement exerts on the valve member a spring force proportional to the fluid pressure prevailing in the chamber.

3. The fluid injection valve according to claim 1, wherein the first spring arrangement exerts a force which acts on the valve member in the direction of an opening of the valve arrangement.

4. The fluid injection valve according to claim 1, wherein the first spring arrangement has a rest state with a prestress, the prestress exerting on the valve member approximately one quarter to three quarters of the force exerted by the fluid pumped into the chamber.

5. The fluid injection valve according to claim 1, wherein the first spring arrangement is formed by a cup-spring arrangement, of which the spring force exerted on the valve member varies with the pressure of the fluid prevailing in the chamber.

6. The fluid injection valve according to claim 5, wherein the cup-spring arrangement is designed in such a way that it acts as a tension or compression spring between the stationary housing of the fluid injection valve and the valve member movable relative thereto.

7. The fluid injection valve according to claim 1, wherein the spring arrangement is designed, arranged and dimensioned in such a way that it shortens or lengthens with rising fluid pressure.

8. The fluid injection valve according to claim 1, wherein the first spring arrangement has a substantially frustoconical shape and is designed and dimensioned in such a way that it shortens along the direction of the movement of the valve member with rising fluid pressure.

9. The fluid injection valve according to claim 8, wherein an outer edge of the substantially frustoconical spring arrangement is fixedly connected to the housing of the fluid injection valve, and an inner edge of said spring arrangement is set up to pull the valve member from its valve seat when the fluid pressure in the housing of the fluid injection valve increases.

10. The fluid injection valve according to claim 9, wherein, at the inner edge of the frustoconical spring arrangement, the latter acts on a rod coupled to the valve member.

11. The fluid injection valve according to claim 1, wherein a lengthening and/or widening of the housing takes place as elastic deformation.

12. The fluid injection valve according to claim 9, wherein a substantially plane annular collar adjoins the inner edge of the frustoconical spring arrangement.

13. The fluid injection valve according to claim 12, wherein a second frustum of a cone directed towards the centre is formed on the inner edge of the frustoconical spring arrangement or on the substantially plane annular collar.

14. The fluid injection valve according to claim 13, wherein the second frustum of a cone is smaller than the first frustoconical spring arrangement and/or is oriented oppositely to the latter.

15. The fluid injection valve according to claim 13, wherein the first frustoconical spring arrangement has a cone angle (k1) of approximately 0.5°-30° in the rest position.

16. The fluid injection valve according to claim 12, wherein the second frustum of a cone has a force-travel spring characteristic by which an opening force inversely proportional to the opening stroke travel of the valve member is exerted on the valve member.

17. The fluid injection valve according to claim 12, wherein, with maximum widening of the housing in the diameter direction, the cone angle (k1) of the first frustoconical spring arrangement is reduced to approximately three quarters to one quarter of the rest position value.

18. The fluid injection valve according to claim 12 wherein the second frustum of a cone has a cone angle of approximately 15°-65° in the rest position.

19. The fluid injection valve according to claim 1, wherein the linear actuator is an electromagnet arrangement having a stator and a rotor, its rotor being kinematically coupled to the valve member or being a part of the valve member.

20. The fluid injection valve according to claim 19, wherein the stator is designed as a multipole stator which has a plurality of stator poles arranged spaced apart side by side and a plurality of excitation coils associated with the respective stator poles and arranged between in each case two stator poles.

21. The fluid injection valve according to claim 20, wherein the armature is designed as a multipole armature, the armature poles of which are aligned with the respective stator poles.

22. The fluid injection valve according to claim 19, wherein the electromagnet arrangement has between the stator and the armature a working air gap preferably oriented transversely with respect to the movement direction of the armature.

23. The fluid injection valve according to claim 1, wherein the linear actuator is arranged at least partly in the interior of the chamber.

24. The fluid injection valve according to claim 19, wherein the stator and/or the armature have at least one fluid passage for fluid in the direction towards the valve arrangement.

25. The fluid injection valve according to claim 19, wherein the electromagnet arrangement acts on a movable valve member of the valve arrangement in order to move said valve member, relative to a stationary valve seat cooperating with the valve member and arranged downstream of the fluid inlet, between an open position and a closed position.

26. The fluid injection valve according to claim 1, wherein a plurality of electromagnet arrangements acting on the valve arrangement are provided.

27. The fluid injection valve according to claim 1, which is set up and dimensioned as a fuel injection valve in order to project into the combustion chamber of a spark-ignition or compression-ignition internal combustion engine.
